(19) United States
(12) Patent Application Publication
(10) Pub. No.: US 2025/0326623 A1
(43) Pub. Date: Oct. 23, 2025

(54) COOLING AND HEATING WATER DISPENSER WITH MULTIPLE WATER INLETS

(71) Applicant: Abdulrahman Al-Bashitie, Dallas, TX (US)

(72) Inventor: Abdulrahman Al-Bashitie, Dallas, TX (US)

(21) Appl. No.: 19/185,188

(22) Filed: Apr. 21, 2025

Related U.S. Application Data
(60) Provisional application No. 63/637,370, filed on Apr. 22, 2024.

(51) Int. Cl. B67D 1/08; B67D 1/00; B67D 1/12

(52) U.S. Cl. CPC B67D 1/0801; B67D 1/0004; B67D 1/0021; B67D 1/0052; B67D 1/0865; B67D 1/0895; B67D 1/1245; B67D 1/1247; B67D 1/0081; B67D 2001/0091; B67D 2001/082

(57) ABSTRACT

A water dispenser system designed to provide enhanced functionality while maintaining the traditional form of conventional dispensers. The system is designed to cool and heat water and to integrate multiple water bottles of varying sizes and water levels. It is designed to operate consistently regardless of whether all water bottle connections are actively in use. The system can autonomously withdraw water from connected bottles, detect depletion in bottles, and switch to consuming available bottles with minimal user intervention. Water level regulation is maintained using float switches in the water tanks. The system supports simultaneous water withdrawal from multiple bottles, reducing the frequency of replacement. Water may be dispensed at hot, cold, or room temperature through corresponding outlet valves. The system does not require structural or plumbing modifications and preserves the external design of standard water dispensers while introducing smart, multi-bottle management.

### FIELD OF THE INVENTION

The present disclosure relates generally to water dispensers with multiple water containers.

### BACKGROUND

Water is a fundamental necessity for maintaining a healthy life. Consumers typically obtain drinking water either from municipal sources through a tap or from bottled water. Bottled water is available in various sizes, ranging from individual single-serving bottles to larger containers, such as three-or five-gallon bottles, commonly used with water dispensers.

Water dispensers are widely used in both residential and commercial settings. They can be classified into two main types: bottle-less dispensers that connect directly to a water supply line and bottle-fed dispensers that require water to be manually supplied from an external bottle. These dispensers accommodate various types of water, including distilled, purified, and spring water, and are capable of heating and cooling the water as needed.

Water dispensers are available in multiple configurations to suit different applications and spatial constraints. These configurations include tabletop, freestanding, top-load, and bottom-load designs. Many dispensers incorporate cold and hot water tanks to ensure the availability of water at desired temperatures.

Bottled water dispensers generally fall into two categories: top-loading dispensers and bottom-loading dispensers. Users must have physical strength to use the top-loading dispensers to lift and invert a water bottle onto the top of the top-loading dispenser. Insertion of a water bottle is less burdensome with the bottom-loading dispensers since the bottle remains upright and does not have to be hoisted or lifted above the water dispenser. A bottom loading dispenser accepts the water bottle at a lower elevation, where the user can connect the water bottle to the dispenser via a tube connecting the water bottle to the dispenser. The bottom loading dispenser design is more user-friendly since it eliminates the need to lift and invert heavy bottles. Float switches are also commonly used to regulate the pumping of water from the bottle to the hot and cold tanks inside the dispenser. However, top loading and bottom loading of dispensers typically connect to a single water bottle at a time, requiring the installation of a replacement water bottle when the previous bottle is empty.

The present invention builds upon these conventional water dispensers by providing a system to connect multiple water bottles to a single water dispenser simultaneously through a series of tubes. The present water dispenser maintains functionality regardless of the size of the connected water bottles (3, 5 gallons or other) or the water level within the connected water bottles, without requiring any modifications or replacements to the connecting parts of the dispenser. The water bottles connected to the system do not need to be full at the same level to maintain functionality of the dispenser system. The present invention ensures that water is completely withdrawn from the water bottles to prevent waste or loss of water despite different water levels in the various water bottles. This unique feature provides users with the option to connect multiple water bottles to a single dispenser at once while ensuring uninterrupted operation even if not all connections are in use simultaneously.

### OBJECTIVES

An object of one embodiment of the present disclosure is to provide a system to dispense water from multiple water bottles simultaneously and without regard to the water level in the multiple bottles.

Another object of the present disclosure is to provide a system capable of providing heated water and/or chilled water and/or room temp. water from multiple bottles connected to a single water dispenser.

Another object of the present disclosure is to reduce the risk of injury for a user inserted a heavy water bottle into a water dispenser.

Another object of the present disclosure is to decrease the frequency of water bottle replacement required with the use of multiple water bottles connected to a single dispenser.

Another object of the present disclosure is to provide a water dispenser with an integrated heating element and hot water tank and integrated cooling element and cold-water tank within a single water dispenser.

### SUMMARY

The present invention discloses a water dispensing system designed to connect multiple water bottles simultaneously to a single dispenser via a series of tubes (flexible tubes or solid). The improved water dispenser system maintains full functionality regardless of bottle size (e.g., 3, or 5 gallons or any other size) or water levels, without requiring component modifications. It ensures complete water withdrawal from bottles, preventing waste and allowing continuous operation even if one or more connections are unused.

The improved water dispenser system comprises a Cooling System with a refrigeration unit and a cold-water tank, a Heating System with a hot-water tank, and a Water Pumping System that transfers water from bottles to storage tanks via pumps, control valves (in one assembly), float switches, and tubing. A User Interface provides buttons for dispensing water, power control, heating/cooling toggling, and a reset mechanism or button. An Indicator System displays operational status (heating active, cooling active, and system power on/off) and alerts users of empty bottles to be replaced. A Control System managed by an electronic control board controls and automates pump operation and determines bottle depletion using (i) Time-Based Detection. If a pump remains active or the storage tank in the dispenser does not fill up beyond a predetermined duration, the electronic control board assumes the bottle being consumed is empty; and (ii) Voltage Monitoring. The electronic control board detects a shift to ‘no-load voltage’ between the pump's electric terminals when a pump runs but does not draw water. If sustained for a predetermined time limit, the electronic control board assumes the bottle being consumed is empty. This method can be used with adding a voltage meter, or a current meter, or a resistance meter to the system to measure the voltage between a pump's electrical terminals or the current flowing through it or the resistance of the pump.

While these are two methods implemented in this system, the invention is not limited to these mechanisms, the electronic control board can be programmed to calculate the volume of water that was transferred through the pump(s) from a bottle to the cold and hot water tanks is also a way the electronic control board can determine a bottle's depletion status. Other methods of determining bottle depletion may also be incorporated within the system as part of its flexible and adaptable design. The present invention enables multiple bottle connections and automated consumption switching, rather than being constrained to a specific depletion detection technique.

The improved water dispenser system supports two configurations. First, a Single-Pump Assembly with Control Valves. When a bottle is assumed to be empty, the electronic control board closes the corresponding control valve to prevent air from entering the system. This function can be achieved by programming the electronic control board to sequentially open and close the control valves to regulate bottle consumption. A solenoid valve may be used as a control valve. Second, a Multi-Pump Assembly Without Control Valves. Independent pumps draw from each bottle, each pump will have an ‘active’ status, where an ‘activated’ pump is a pump that the electronic control board will activate to withdraw water to fill the cold and hot water tanks and a ‘deactivated’ pump is a pump the electronic control board will not utilize to withdraw water from after assuming the bottle associated with that pump is depleted.

The advantages of this improved water dispenser system include automated water source switching, multiple pumping configurations, and enhanced efficiency in water bottle usage. The system integrates reset functions via a manual button or an automatic compartment door mechanism for dispensers with an enclosure that contains a water bottle. This invention enhances and improves upon traditional dispensers by offering a smart, multi-bottle management system, ensuring uninterrupted water supply, minimizing wasted water in bottles, and improving user convenience by minimizing bottle replacement, while having cold and/or hot and/or room temperature water supply for the consumer.

### BRIEF DESCRIPTION OF THE DRAWINGS

For a more complete understanding of this disclosure and its features, reference is now made to the following description, taken in conjunction with the accompanying drawings, in which:

FIG. 1 shows a cooling and heating water dispenser with multiple water inlets using multiple valves.

FIG. 2 shows a cooling and heating water dispenser with multiple water inlets using multiple pumps.

FIG. 3 shows an alternative wiring diagram for the refrigerant compressor and heating system with a common neutral electrical connection.

FIG. 4 shows a cooling and heating water dispenser with multiple outlets.

### REFERENCE NUMBERS

1. COVER
2. RESET BUTTON
3. INDICATOR FOR COOLING (WHEN COOLING IS ACTIVE)
4. INDICATOR FOR HEATING (WHEN HEATING IS ACTIVE)
5. INDICATOR FOR EMPTY BOTTLES
6. WATER OUTLET/VALVE FOR HOT WATER
7. WATER OUTLET/VALVE FOR COLD WATER
8. WATER OUTLET/VALVE FOR ROOM TEMPERATURE
9. WATER BOTTLES
10. CONDENSER
11. WATER TUBES
12. POWER ON INDICATOR
13. HOT WATER TANK IN DISPENSER
14. EMPTY TANK FLOAT SWITCH
15. WATER PUMP
16. COLD WATER TANK IN DISPENSER
17. REFRIGERANT TUBES
18. ELECTRICAL WIRE
19. CONTROL VALVE
20. ELECTRICAL POWER INLET (FROM POWER SOURCE)
21. LOW WATER FLOAT SWITCH
22. ELECTRONIC CONTROL BOARD
23. EVAPORATOR
24.1 ELECTRIC MANUAL SWITCH FOR COOLING SYSTEM (ON/OFF)
24.2 ELECTRIC MANUAL SWITCH FOR HEATING SYSTEM (ON/OFF)
25. WATER HEATING ELEMENT
26. TEMPERATURE SENSOR
27. THROTTLING VALVE/CAPILLARY TUBE
28. REFRIGERANT
29. COM PRESSOR
30. MIXING HEADER

### DETAILED DESCRIPTION

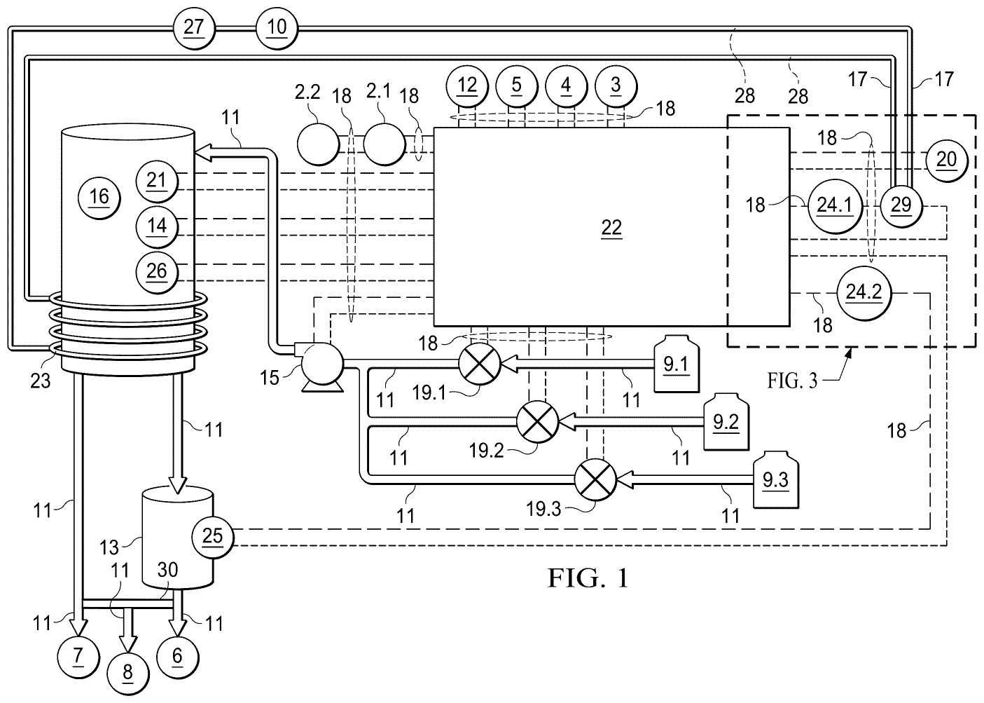

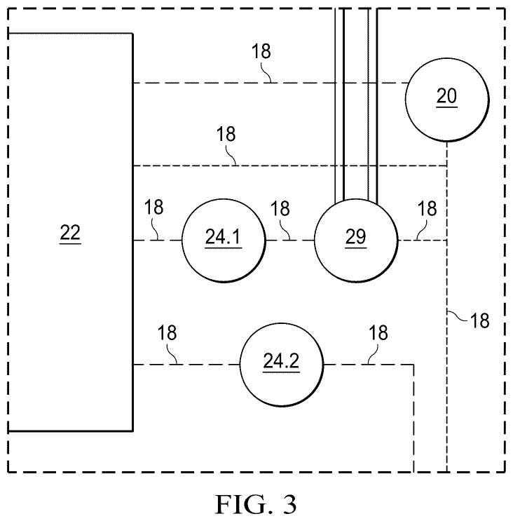

FIG. 1 illustrates an embodiment of a water dispenser system that employs a single water pump 15 and multiple control valves (19). This embodiment of the water dispenser system includes three control valves, first control valve 19.1, second control valve 19.2, and third control valve 19.3, each corresponding to one of three water bottles, first water bottle 9.1, second water bottle 9.2, and third water bottle 9.3, with all components managed by the electronic control board 22. Each control valve 19 is connected to an independent water bottle 9 through water tubes 11, and the control valves 19 are connected to the water pump 15 through additional water tubes 11 and fittings. The water pump 15 is connected through a water tube 11 to the cold-water tank 16. While the water pump 15 can be configured to connect to both the hot water tank 13 and the cold-water tank 16 using separate water tubes 11, for simplicity, it is shown connected only to the cold-water tank 16 in this embodiment. The cold-water tank 16 and the hot water tank 13 are interconnected through a water tube 11 that allows water to transfer between them. The control valves 19 and the water pump 15 are connected to the electronic control board 22. The electronic control board 22 is wired to all system components through electrical wiring. The electrical power inlet 20 supplies power to the system and connects to the electronic control board 22. For simplicity, if the electrical power inlet 20 is compatible with both the refrigeration compressor 29 and the water heating element 25, the refrigeration compressor 29 and the water heating element 25 can both have a common neutral wire with the electrical power inlet (see FIG. 3). However, independent pairs of wires may also be used to connect the refrigeration compressor 29 and the water heating element 25 to the electronic control board 22 without having a common neutral wire with the electric power source 20 as shown here in FIG. 1.

The improved water dispenser system includes two float switches: a low water float switch 21 and an empty tank float switch 14. While the system can function with only the low water float switch 21 to notify the electronic control board 22 of a low water level, incorporating both the low water float switch 21 and the empty tank float switch 14 provides greater flexibility and additional options for programming the electronic control board 22. The hot water tank 13 includes a water heating system, where the water heating element 25 is connected to the electronic control board 22. A water tube 11 connects the cold-water tank 16 to the water outlet/valve for cold-water 7, while another water tube 11 connects the hot water tank 13 to the water outlet/valve for hot water 6. The mixing header 30 connects the cold-water tank water tube and the hot water tank water tube. The mixing header prevents water from leaving the water tubes connected to the cold-water tank and the hot water tank. This mixing header 30 connects the cold-water tank 16 and the hot water tank 13 to mix the water to supply room-temperature water through the water outlet/valve 8. A temperature sensor 26 is attached to the cold-water tank 16 to monitor the water temperature. Although the water heating system with the water heating element 25 is self-regulating and operates independently of the electronic control board 22, an additional temperature sensor 26 can be connected to the hot water tank 13 and integrated with the electronic control board 22 to provide advanced temperature regulation for improved accuracy. The refrigeration system includes a refrigeration compressor 29 that compresses refrigerant 28 and sends it through refrigerant tubes 17. The compressed refrigerant 28 passes through a condenser 10, followed by a throttling valve/capillary tube 27, before entering the evaporator 23, which acts as a heat exchanger that cools the water in the cold-water tank 16. The refrigerant 28 then returns to the refrigeration compressor 29 through a refrigerant tube 17 to complete the cycle. A reset button 2.1 is connected to the electronic control board 22, with an option for an additional reset button 2.2 if desired. However, the system can function with just one reset button 2.1. The system also includes multiple indicators connected to the electronic control board 22, including (i) a power-on 12 that indicates when the system is powered, (ii) an indicator for cooling 3 that activates when the refrigeration compressor 29 is operating, (iii) an indicator for heating 4 that activates when the water heating element 25 is operating, (iv) an indicator for empty bottles 5, signaling when the water bottles 9 need replacement, note that these indicators can be LED indicators, however, the system will remain functional without these indicators. Electrical manual switches 24.1 and 24.2 can also be incorporated into the system to manually control the on/off status of the cooling and heating systems. However, the system will remain functional without these switches 24.1 and 24.2.

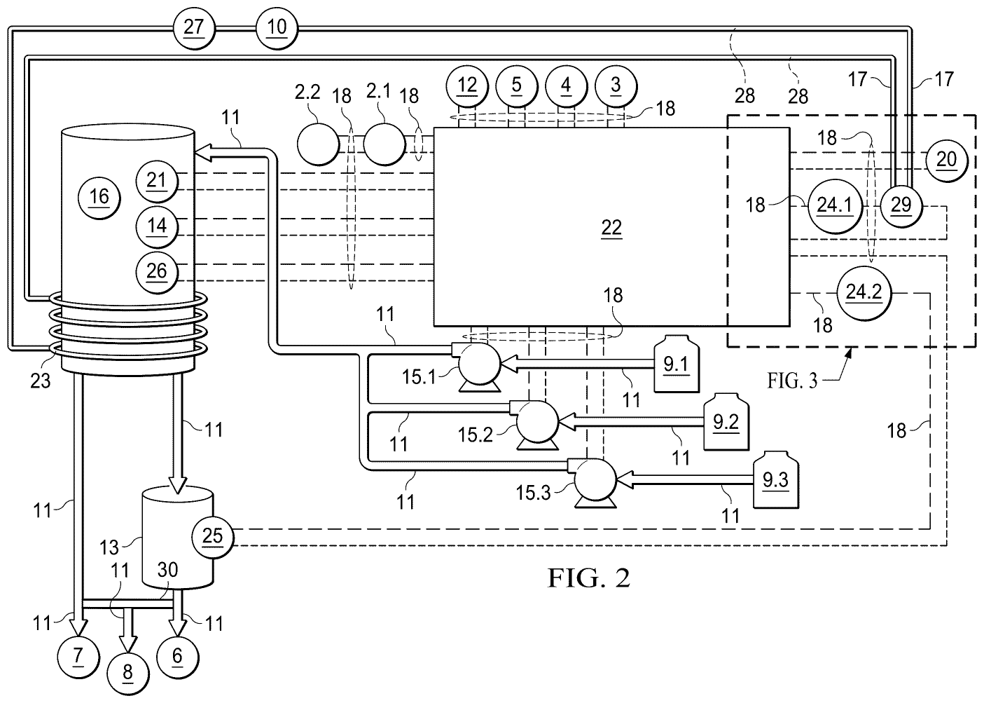

FIG. 2 illustrates an embodiment of the water dispenser system that utilizes multiple water pumps 15. In this configuration, the electronic control board 22 is connected to three water pumps, a first water pump 15.1, a second water pump 15.2, and a third water pump 15.3 through wires 18. Each water pump 15 is connected to a separate water bottle through water tubes 11, which also connect the pumps 15 to the cold-water tank 16 and the hot water tank 13. The remaining components of the system are identical to those described in FIG. 1.

FIG. 3 presents an alternative wiring diagram where the refrigeration compressor 29 and the water heating element 25 (refer to FIGS. 1 and 2 for heating element 25) share a common neutral connection with the electrical power source 20, instead of having separate connections with the electronic control board 22. The electrical manual switches 24.1 and 24.2 can be used by the consumer to deactivate cooling and/or heating systems.

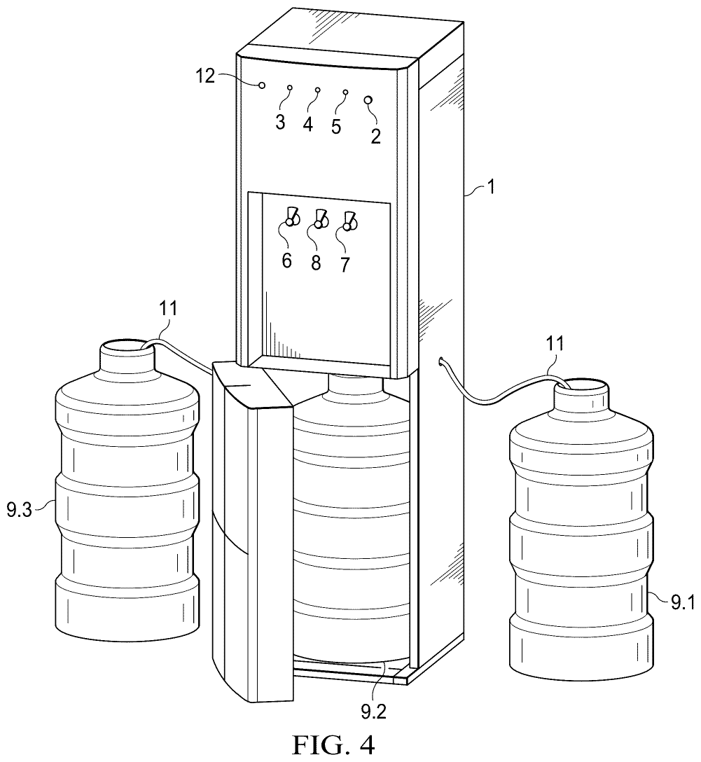

FIG. 4 illustrates an example of the exterior view of a water dispenser with multiple water inlets 11 and storage for a water bottle 9.2, which is connected to the dispenser as a conventional bottom-loaded dispenser. Additional water tubes 11 are shown on the sides of the dispenser, allowing for connections to a first water bottle 9.1 and a third water bottle 9.3. Most of the cooling system components are enclosed within the cover 1 and not visible on this FIG. 4, while the condenser 10 is positioned at the back of the dispenser. The cover 1 serves as an encasement that houses other components, displays indicators, LED indicator for cooling 3, LED indicator for heating 4, LED indicator for empty bottles 5, and LED indicator for power off/on 12. The reset button 2 is also at the upper portion of the cover 1 and electrical manual switches 24 for turning the systems on or off, although these switches are not visible in the figure but will be attached to the cover in the back side. The water outlet valves are located below the LED indicators and reset button 2 on the cover 1. The water outlet or valve for hot water 6, water outlet or valve for cold water 7, and water outlet or valve for room temperature water 8 are adjacent to each other and positioned between the LED indicators and the water bottles.

The cover 1 features a door that provides access to a compartment designed to store a centrally located water bottle 9.2, similar to a conventional water dispenser. This figure also depicts water tubes 11 that can be used to connect an additional water bottle 9.1 on a side of dispenser and a third water bottle 9.3, also on a side of the dispenser to the improved water dispenser. It is important to note that FIG. 4 shows a single embodiment of the exterior view of a water dispenser with multiple water inlets. This invention is not limited to this design or appearance illustrated in the figures, nor to the number of bottles that can be connected. The dispenser may be designed with different exterior configurations of the components while maintaining the core functionality described in this disclosure.

What is claimed is:

1. A system for dispensing water from multiple sources, comprised of:
a series of water bottles,
a series of water tubes,
a series of outlet valves,
a cooling system, further comprised of a cold-water tank, refrigerant, compressor, condenser, throttling device, and evaporator,
a heating system, further comprised of a hot water tank and a water heating element,
a water pumping system, further comprised of said series of water tubes, a series of control valves, and a water pump,
wherein each of said water tubes is connected to a corresponding number of each of said water bottles, each of said water tubes is further connected to corresponding number of said water control valves, wherein all of said control valves are connected to said water pump, wherein said water pump is further connected to said at least one water tank, wherein said cold-water tank is connected to one of said outlet valves, wherein said hot water tank is connected to one of said outlet valves, and
at least one electrical control board connected to system components by electrical wires.

2. The system of claim 1, wherein said electrical control board integrates with said cooling system with a system of cooling system electrical wires, wherein said electrical control board integrates said heating system with a system of heating system electrical wires, wherein said cooling system is powered by electrical power through said cooling system electrical wires connected to said compressor, wherein said compressor is connected to said refrigerant via refrigerant filled tubes, wherein said refrigerant passes through said condenser and said throttling device, wherein said refrigerant passes through said refrigerant filled tubes connected to said evaporator to cool said water in said cold-water tank, wherein said water heating element of said water heating system is powered by said electrical power run through said heating system electrical wires.

3. The system of claim 1, wherein said electrical control board detects depletion of said water bottles as determined by a method selected from the group consisting of: measurement of voltage, measurement of current, measurement of resistance across said pump's electrical terminals; time-based monitoring of said single pump's pumping activity, and time-based monitoring of detecting low water level by a float switch in said water tank, wherein said electrical control board directs the system to extract said water from any non-depleted water bottle connected to said system until such time as all of said series of water bottles connected are depleted.

4. The system of claim 1, wherein a low water level monitoring instrument is integrated into said water tank, wherein said low water level monitoring instrument is selected from the group consisting of: a float switch, an ultrasonic sensor and a pressure switch.

5. The system of claim 1, wherein an empty tank monitoring instrument is integrated into said water tank, wherein said empty tank monitoring instrument is selected from the group consisting of: a float switch, an ultrasonic sensor and a pressure switch.

6. The system of claim 1, wherein said cold water tank is connected by said cold-water tank water tube to a cold-water outlet valve, wherein said hot water tank is connected by hot water tank water tube to a hot water outlet valve, wherein a third water outlet valve is connected by a mixing header to said cold water tank water tube on a first end of said mixing header and said hot water tank water tube on a second end of said mixing header.

7. The system of claim 1, wherein a user interface is integrated to the system and comprised of instruments selected from the group consisting of: a reset button, a water dispenser system power control manual switch, a cooling system manual power switch, a heating system manual power switch, an indicator for heating status, an indicator for cooling status and an indicator for depleted bottle status.

8. The system of claim 7, wherein said reset control is triggered by the activity selected from the group consisting of: manually depressing reset button, automatically by opening cover door, and automatically by closing cover door.

9. The system of claim 1, wherein said control valves are solenoid valves.

10. The system of claim 1, wherein at least one temperature switch is utilized to regulate the temperature of said water tank.

11. The system of claim 1, wherein at least one temperature sensor is utilized to regulate the temperature of said water tank.

12. A system for dispensing water from multiple sources, comprised of
a series of water bottles,
a series of water inlet tubes,
a series of outlet valves,
a cooling system, further comprised of a cold-water tank, refrigerant, compressor, condenser, throttling device, and evaporator,
a heating system, further comprised of a hot water tank and a water heating element,
a water pumping system, further comprised of said series of water inlet tubes and a series of water pumps,
wherein each of said water tubes is connected to a corresponding number of each of said water bottles, each of said water tubes is further connected to corresponding number of said water pumps, wherein all of said water pumps are further connected to said at least one water tank, wherein said cold-water tank is connected to one of said outlet valves, wherein said hot water tank is connected to one of said outlet valves, and
at least one electrical control board connected to system components by electrical wire.

13. The system of claim 12, wherein said electrical control board integrates with said cooling system with a system of cooling system electrical wires, wherein said electrical control board integrates said heating system with a system of heating system electrical wires, wherein said cooling system is powered by electrical power through said cooling system electrical wires connected to said compressor, wherein said compressor is connected to said refrigerant via refrigerant filled tubes, wherein said refrigerant passes through said condenser and said throttling device, wherein said refrigerant passes through said refrigerant filled tubes connected to said evaporator to cool said water in said cold-water tank, wherein said water heating element of said water heating system is powered by said electrical power run through said heating system electrical wires.

14. The system of claim 12, wherein said electrical control board detects depletion of said water bottles as determined by a method selected from the group consisting of: measurement of voltage, measurement of current, measurement of resistance across said pump's electrical terminals; time-based monitoring of said single pump's pumping activity, and time-based monitoring of detecting low water level by a float switch in said water tank, wherein said electrical control board directs the system to extract said water from any non-depleted water bottle connected to said system until such time as all of said series of water bottles connected are depleted.

15. The system of claim 12 wherein a low water level monitoring instrument is integrated into said water tank, wherein said low water level monitoring instrument is selected from the group consisting of: a float switch, an ultrasonic sensor and a pressure switch.

16. The system of claim 12, wherein an empty tank monitoring instrument is integrated into said water tank, wherein said empty tank monitoring instrument is selected from the group consisting of: a float switch, an ultrasonic sensor and a pressure switch.

17. The system of claim 12, wherein said cold water tank is connected by said cold-water tank water tube to a cold-water outlet valve, wherein said hot water tank is connected by hot water tank water tube to a hot water outlet valve, wherein a third water outlet valve is connected by a mixing header to said cold water tank water tube on a first end of said mixing header and said hot water tank water tube on a second end of said mixing header.

18. The system of claim 12, wherein a user interface is integrated to the system and comprised of instruments selected from the group consisting of: a reset button, a water dispenser system power control manual switch, a cooling system manual power switch, a heating system manual power switch, an indicator for heating status, an indicator for cooling status and an indicator for depleted bottle status.

19. The system of claim 18, wherein said reset control is triggered by the activity selected from the group consisting of: manually depressing reset button, automatically by opening cover door, and automatically by closing cover door.

20. The system of claim 1, wherein at least one temperature switch is utilized to regulate the temperature of said water tank.

21. The system of claim 12, wherein at least one temperature sensor is utilized to regulate the temperature of said water tank.

22. A method of dispensing water from multiple water bottles, comprising:
Connecting a series of water bottles to a water dispenser via inlet tubes;
Directing water from said water bottles using control valves connected to a pump,
Extracting said water from said water bottles using said single pump
Transferring said water through said single pump to at least one water tank;
Dispensing said water through an outlet valve connected to said water tank;
Monitoring the current water depletion status of each of said water bottles on an electrical control board;
Ceasing water dispensing operations when all of said water bottles are depleted.

23. The method of claim 22, wherein a hot water tank is connected to a cold-water tank, wherein said water flows directly from said cold water tank into said hot water tank via water tube.

24. The method of claim 22, wherein said outlet valve is selected from the group consisting of: cold water outlet valve receiving said water from said cold-water tank, hot water outlet valve receiving said water from said hot water tank, and room-temperature water outlet valve receiving said water from said cold-water tank and said hot water tank.

25. The method of claim 22, wherein said current water depletion status of each of said water bottle is determined by a method selected from the group consisting of: measurement of voltage, measurement of current, measurement of resistance across said pump's electrical terminals; time-based monitoring of the activity of said single pump activity, and time-based monitoring of detecting low water level by a float switch in said water tank.

26. A method of dispensing water from multiple water bottles, comprising:
Connecting a series of replaceable water bottles to a water dispenser via inlet tubes;
Directing water from said water bottles using a series of pumps,
Transferring said water through said pumps to at least one water tank;
Dispensing said water through an outlet valve connected to said water tank;
Monitoring the current water depletion status of each of said water bottles on an electrical control board;
Ceasing water dispensing operations when all of said water bottles are depleted.

27. The method of claim 26, wherein a hot water tank is connected to a cold-water tank, wherein said water flows directly from said cold water tank into said hot water tank via water tube.

28. The method of claim 26, wherein said outlet valve is selected from the group consisting of:
cold water outlet valve receiving said water from said a cold-water tank, hot water outlet valve receiving said water from said a hot water tank, and room-temperature water outlet valve receiving said water from said cold water tank and said hot water tank.

29. The method of claim 26, wherein said current water depletion status of each of said water bottle is determined by a method selected from the group consisting of: measurement of voltage, measurement of current, measurement of resistance across said pump's electrical terminals; time-based monitoring of the activity of said single pump activity, and time-based monitoring of detecting low water level by a float switch in said water tank.
